(19) United States
(12) Patent Application Publication
(10) Pub. No.: US 2020/0327078 A1
(43) Pub. Date: Oct. 15, 2020

(54) DATA PROCESSING METHOD AND DEVICE, DMA CONTROLLER, AND COMPUTER READABLE STORAGE MEDIUM

(71) Applicant: SZ DJI Technology Co., Ltd., Shenzhen (CN)

(72) Inventors: Yao Zhao, Shenzhen (CN); Kang Yang, Shenzhen (CN); Sijin Li, Shenzhen (CN)

(21) Appl. No.: 16/914,704

(22) Filed: Jun. 29, 2020

Related U.S. Application Data
(63) Continuation of application No. PCT/CN2017/120235, filed on Dec. 29, 2017.

(51) Int. Cl. G06F 13/28; G06F 13/16

(52) U.S. Cl. CPC G06F 13/28; G06N 3/063; G06F 13/1668

(57) ABSTRACT

A data processing method, a device, a direct memory access (DMA) controller, and a computer readable storage medium are provided. The method includes acquiring feature information and parameter information of an original input feature map; generating first DMA configuration information according to the feature information and the parameter information; generating second DMA configuration information according to the feature information; generating third DMA configuration information according to the feature information and the parameter information; constructing a target input feature map according to the first DMA configuration information; reading input data from the original input feature map according to the second DMA configuration information; and storing the input data into the target input feature map according to the third DMA configuration information.

### CROSS-REFERENCE TO RELATED APPLICATION

This application is a continuation of International Application No. PCT/CN2017/120235, filed Dec. 29, 2017, the entire content of which is incorporated herein by reference.

### TECHNICAL FIELD

The present disclosure relates to the field of image processing technology and, more particularly, to a data processing method, a device, a direct memory access (DMA) controller, and a computer readable storage medium.

### BACKGROUND

In machine learning, a convolution neural network (CNN) is a feedforward neural network where its artificial neurons may respond to a portion of surrounding cells within a coverage region, which may have excellent performance for large-scale imaging processing. The CNN is a multiple layer neural network, where each layer is composed of multiple two-dimensional planes, and each plane is composed of multiple independent neurons. The CNN is composed of a convolution layer and a pooling layer, the convolution layer is used to extract various features of an image, the pooling layer is used to perform feature extraction twice on an original feature signal, thereby reducing feature resolution, training parameters and model overfitting degree. Furthermore, the CNN may reduce network complexity due to the CNN's special structure of local weighted value sharing; especially, the complexity of data reconstruction during the feature extraction and classification may be avoided because of the characteristic that an image of a multiple dimensional input vector may be directly inputted into the network, thereby making the CNN to be widely used in various fields.

Various data move tasks may be involved in the CNN, and traditional data move tasks may be implemented by a central processing unit (CPU), which may have a low data move efficiency and increase excessive load on the CPU. For example, image algorithms may involve operations on fixed matrices, such as Gaussian filtering matrices and the like; when completing matrix operations, the CPU may also need to perform data movement, which may increase excessive load on the CPU.

### SUMMARY

In accordance with the disclosure, a data processing method is provided in the present disclosure. The method includes acquiring feature information and parameter information of an original input feature map; generating first DMA configuration information according to the feature information and the parameter information; generating second DMA configuration information according to the feature information; generating third DMA configuration information according to the feature information and the parameter information; constructing a target input feature map according to the first DMA configuration information; reading input data from the original input feature map according to the second DMA configuration information; and storing the input data into the target input feature map according to the third DMA configuration information.

Also in accordance with the disclosure, a DMA controller is provided in the present disclosure. The DMA controller is configured to acquire feature information and parameter information of an original input feature map; generate first DMA configuration information according to the feature information and the parameter information; generate second DMA configuration information according to the feature information; generate third DMA configuration information according to the feature information and the parameter information; construct a target input feature map according to the first DMA configuration information; read input data from the original input feature map according to the second DMA configuration information; and store the input data into the target input feature map according to the third DMA configuration information.

Also in accordance with the disclosure, a data processing device is provided in the present disclosure. The device includes a memory, configured to store program code, and a direct memory access (DMA) controller, configured to call the program code. When the program code is executed, the DMA controller is configured to perform acquiring feature information and parameter information of an original input feature map; generating first DMA configuration information according to the feature information and the parameter information; generating second DMA configuration information according to the feature information; generating third DMA configuration information according to the feature information and the parameter information; constructing a target input feature map according to the first DMA configuration information; reading input data from the original input feature map according to the second DMA configuration information; and storing the input data into the target input feature map according to the third DMA configuration information.

### BRIEF DESCRIPTION OF THE DRAWINGS

In order to more clearly illustrate technical solutions in embodiments of the present disclosure, drawings required for describing the embodiments are briefly illustrated hereinafter. Obviously, the following drawings are merely examples for illustrative purposes according to various disclosed embodiments of the present disclosure and are not intended to limit the scope of the present disclosure. Those skilled in the art may obtain other drawings according to the drawings of the present disclosure without any creative efforts.

FIGS. 1A-1G illustrate a schematic of a working principle of a DMA controller;

FIG. 2 illustrates a schematic of a data processing method according to various disclosed embodiments of the present disclosure;

FIGS. 3A-3F illustrate a schematic of performing a padding process on an original input feature map;

FIGS. 4A-4F illustrate a schematic of performing a deconvolution process on an original input feature map; and

FIG. 5 illustrates a block diagram of a data processing device according to various disclosed embodiments of the present disclosure.

### DETAILED DESCRIPTION OF THE EMBODIMENTS

The technical solutions in the embodiments of the present disclosure are clearly and completely described in the following with reference to the accompanying drawings in the embodiments of the present disclosure. It is obvious that the described embodiments are merely a part of the embodiments of the present disclosure, but not all embodiments. All other embodiments, based on the embodiments of the present disclosure, obtained by those skilled in the art without creative efforts are within the scope of the present disclosure. Moreover, in the case of no conflict, the following embodiments and features of the embodiments may be combined with each other.

The terminology used herein is merely for the purpose of describing particular embodiments and is not intended to limit the scope of the present disclosure. The singular forms “a”, “the” and “such” used in present disclosure and in the claims are intended to include the plural forms as well, unless the context clearly indicates other meanings. It should be understood that the term “and/or” as used herein refers to any or all possible combinations that include one or more of associated listed items.

Although the terms first, second, third, and the like may be used in the present disclosure to describe various information, such information should not be limited to these terms. These terms are used to distinguish the same type of information from each other. For example, without departing from the scope of the present disclosure, the first information may also be referred to as the second information, and similarly, the second information may also be referred to as the first information, which may depend on the context. Moreover, the word “if” can be interpreted as “at . . . ”, or “when . . . ”, or “respond to determination”.

The embodiments of the present disclosure provide a data processing method, which may be applied to a DMA controller. In the CNN, the DMA controller, not the CPU, may be used to implement data movement, thereby reducing CPU load, moving data more efficiently, and further accelerating the CNN operation.

The DMA controller is a peripheral which moves data inside a system and allow data transfer between hardware devices with different speeds; the data move operation may not depend on the CPU, and the DMA controller may instruct the data needed to be processed by the CPU in place through DMA interrupts. Furthermore, the CPU may merely need to establish DMA transfer, respond to DMA interrupts and process the data moved to internal memory by the DMA controller.

For a single DMA transfer process, one source address, one destination address and a stride length may be specified, where the stride length is stride information. After each write operation is completed, the sum of a current address and the stride length is a next address to be processed. Such transmission with the “normal” stride length is called 1D transmission.

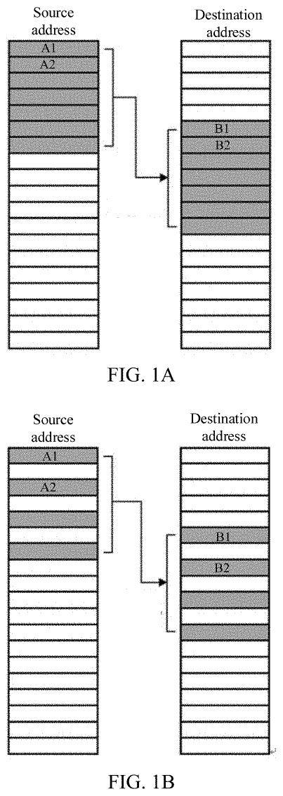

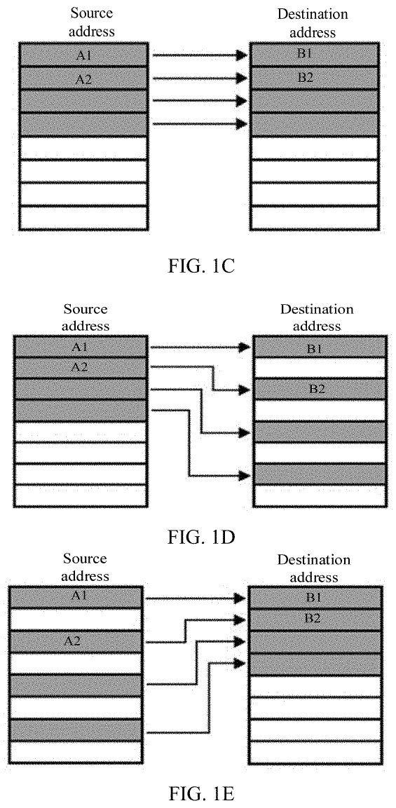

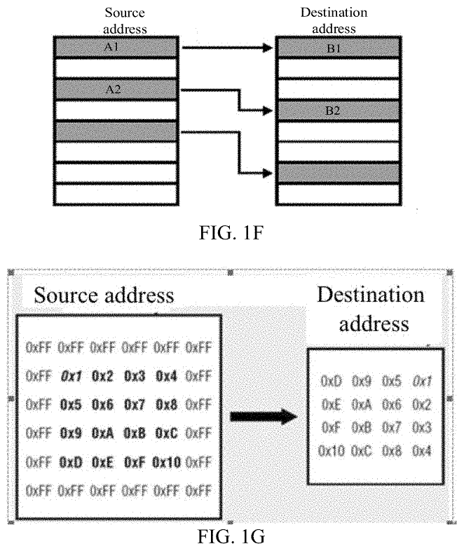

Referring to FIG. 1A, after reading data from a first source address A1, the DMA controller may write the data to a first destination address B1. Then, the first source address A1 may be added to the stride length of 1 to obtain a second source address A2, and the first destination address B1 may be added to the stride length of 1 to obtain a second destination address B2. After reading data from the second source address A2, the DMA controller may write the data to the second destination address B2, and so on.

Referring to FIG. 1B, after reading data from the first source address A1, the DMA controller may write the data to the first destination address B1. Then, the first source address A1 may be added to the stride length of 2 to obtain the second source address A2, and the first destination address B1 may be added to the stride length of 2 to obtain the second destination address B2. After reading data from the second source address A2, the DMA controller may write the data to the second destination address B2, and so on.

Compared with FIG. 1A, the “normal” stride length of 1 is modified to the “non-normal” stride length of 2 in FIG. B, so the 1D transmission may skip some addresses to increase the flexibility of the 1D transmission.

2D transmission is an extension of the 1D transmission, which is widely used in the field of imaging processing. In a 2D transmission process, the following variables may be used: X direction count configuration (X_COUNT), X direction stride configuration (X_STRIDE), Y direction count configuration (Y_COUNT), and Y direction stride configuration (Y_STRIDE).

The 2D transmission is a nested loop. An inner loop parameter may be determined by the X direction count configuration (X_COUNT) and the X direction stride configuration (X_STRIDE), and an outer loop parameter may be determined by the Y direction count configuration (Y_COUNT) and the Y direction stride configuration (Y_STRIDE). The 1D transmission may correspond to the inner loop of the 2D transmission. When incrementing x each time, the X direction stride configuration may determine the stride length of the address increment; when incrementing y each time, the Y direction stride configuration may determine the stride length of the address increment; the X direction count configuration may determine the quantity of x increments; and the Y direction count configuration may determine the quantity of y increments. Furthermore, the Y direction stride configuration may be negative, thereby allowing the address inverse convolution of the DMA controller in a buffer.

FIGS. 1C-1F are schematics of application scenarios of 1D-to-1D, 1D-to-2D, 2D-to-1D, and 2D-to-2D. Obviously, the above-mentioned 2D transmission process enriches the application scenarios of DMA.

3D transmission is a further extension of the 1D transmission, and the following variables may be used: the X direction count configuration (X_COUNT), the X direction stride configuration (X_STRIDE), the Y direction count configuration (Y_COUNT), the Y direction stride configuration (Y_STRIDE), Z direction count configuration (Z_COUNT), and Z direction stride configuration (Z_STRIDE). The 3D transmission is a triple nested loop. An inner loop parameter may be determined by the X direction count configuration (X_COUNT) and the X direction stride configuration (X_STRIDE); an middle loop parameter may be determined by the Y direction count configuration (Y_COUNT) and the Y direction stride configuration (Y_STRIDE); and an outer loop parameter may be determined by the Z direction count configuration (Z_COUNT) and the Z direction stride configuration (Z_STRIDE).

When incrementing x each time, the X direction stride configuration may determine the stride length of the address increment; when incrementing y each time, the Y direction stride configuration may determine the stride length of the address increment; and when incrementing z each time, the Z direction stride configuration may determine the stride length of the address increment. The X direction count configuration may determine the quantity of x increments; the Y direction count configuration may determine the quantity of y increments; and the Z direction count configuration may determine the quantity of z increments. Furthermore, the Y direction stride configuration may be negative, and the Z direction stride configuration may be negative, thereby allowing the address reverse convolution in a buffer.

The above-mentioned process may be described in one embodiment combining a 2D-to-2D matrix extraction and a rotation by 90 degrees hereinafter. As shown in FIG. 1G, it is assumed that a source matrix is stored in a row order and a starting address is A; and a destination matrix is stored in a row order and a starting address is A′. Therefore, when reading the data, the source address may be A+7, the X direction count configuration may be 4, the X direction stride configuration may be 1, the Y direction count configuration may be 4, the Y direction stride configuration may be 3, the Z direction count configuration may be 0, and the Z direction stride configuration may be 0. When writing the data, the destination address may be A′+3, the X direction count configuration may be 4, the X direction stride configuration may be 4, the Y direction count configuration may be 4, the Y direction stride configuration may be −13, the Z direction count configuration may be 0, and the Z direction stride configuration may be 0.

Referring to FIG. 1G, the DMA controller may read data from a source address 0x1 (i.e., the starting address A+7), and then write the read data into a destination address 0x1 (i.e., the starting address A′+3); the DMA controller may read data from a source address 0x2 (i.e., 0x1+the X direction stride configuration of 1), and then write the read data into a destination address 0x2 (i.e., 0x1+the X direction stride configuration of 4); the DMA controller may read data from a source address 0x3, and then write the read data into a destination address 0x3; and the DMA controller may read data from a source address 0x4, and then write the read data into a destination address 0x4.

After the above-mentioned process, the data has been read 4 times in the X direction in the data read process, that is, the X direction count configuration of 4 is reached, so the data has been executed in the Y direction for one time; and since the Y direction stride configuration is 3, 3 is added to the source address 0x4 to obtain a source address 0x5. Furthermore, in the data write process, the data has been read 4 times in the X direction, that is, the X direction count configuration of 4 is reached, so the data has been executed in the Y direction one time; and since the Y direction stride configuration is −13, 13 is subtracted from the destination address 0x4 to obtain a destination address 0x5. Data may be read from the source address 0x5, and the read data may be written into the destination address 0x5; then, data may be read from a source address 0x6, and the read data may be written into a destination address 0x6; then, data may be read from a source address 0x7, and the read data may be written into a destination address 0x7; then, data may be read from a source address 0x8, and the read data may be written into a destination address 0x8.

After the above-mentioned process, in the data read process, the data has been read 4 times in the X direction, that is, the X direction count configuration of 4 is reached, so the data has been executed in the Y direction one time; in the data write process, the data has been read 4 times in the X direction, that is, the X direction count configuration of 4 is reached, so the data has been executed in the Y direction one time, and so on. The data processing effect may be shown in FIG. 1G.

As long as the X direction count configuration (X_COUNT), the X direction stride configuration (X_STRIDE), the Y direction count configuration (Y_COUNT), the Y direction stride configuration (Y_STRIDE), the Z direction count configuration (Z_COUNT), and the Z direction stride configuration (Z_STRIDE) are provided, the DMA controller may use the above-mentioned parameters to complete the data processing. That is, the DMA controller may read the data from the source address using parameters of the data read process, and also write the data into the destination address using parameters of the data write process.

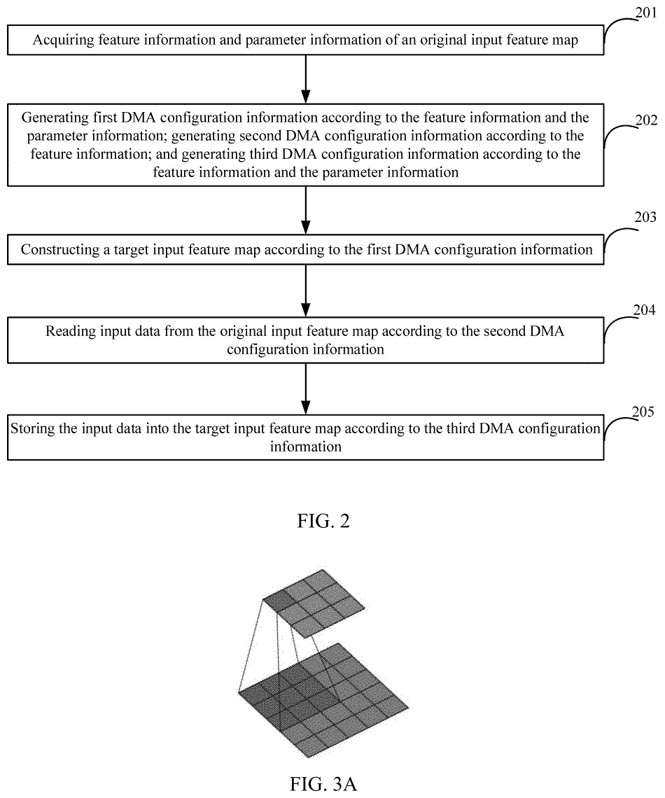

Based on the working principle of the DMA controller, in the convolutional neural network, the DMA controller may be used to implement the data move tasks, instead of using the CPU to implement the data move tasks. FIG. 2 shows an embodiment of a flow chart of the above-mentioned data processing method in the convolutional neural network. The method may be applied to the DMA controller, and include the following steps.

At step 201, feature information and parameter information of an original input feature map may be acquired.

At step 202, second DMA configuration information may be generated according to the feature information, and first DMA configuration information and third DMA configuration information may be generated according to the feature information and the parameter information.

At step 203, a target input feature map may be constructed according to the first DMA configuration information.

At step 204, input data may be read from the original input feature map according to the second DMA configuration information.

At step 205, the input data may be stored in the target input feature map according to the third DMA configuration information.

In one embodiment, the above-mentioned execution order may merely an example for convenience of description. In practical applications, the execution order between steps may also be changed, which may not be limited in the present disclosure. Furthermore, in other embodiments, the steps of the corresponding method may not be necessarily performed in the order shown and described in the present disclosure, and the steps of the method may be more or less than the steps described in the present disclosure. A single step described in the present disclosure may be divided into multiple steps for description, and multiple steps in the present disclosure may be combined into a single step for description in other embodiments.

The above-mentioned parameter information may include, but may not be limited to, padding information and/or stride information. The padding information may include, but may not be limited to, a padding size M along a horizontal direction, and a padding size R along a vertical direction. The stride information may include, but may not be limited to, a stride length S.

The above-mentioned feature information may include, but may not be limited to, a width W and a height H of the original input image map. Furthermore, the above-mentioned feature information may also include a quantity N of channels, that is, a quantity N, of the original input image map.

In the above-mentioned embodiments, the original input feature map is an initial feature map, and the DMA controller may read data from the original input feature map, that is, the original input feature map may be used as source data. The target input feature map is a target feature map, and the DMA controller may write data into the target input feature map. The DMA controller may read the data from the original input feature map and write the data into the target input feature map.

In the above-mentioned embodiments, the original input feature map is known, so the feature information and the parameter information may be acquired from the original input feature map, the second DMA configuration information may be generated according to the feature information, and the first DMA configuration information and the third DMA configuration information may be generated according to the feature information and the parameter information.

The first DMA configuration information may be the DMA configuration used to construct the target input feature map, so the target input feature map may be constructed according to the first DMA configuration information. The constructed target input feature map may be a target input feature map in an initial state without writing the data in the original input feature map, where the target input feature map may be a specific feature map and may also be a feature map of all zeros or ones.

The second DMA configuration information may be the DMA configuration used to read data from the original input feature map, so input data may be read from the original input feature map according to the second DMA configuration information; and such reading process may also be a process of reading data from the source address (the original input feature map).

The third DMA configuration information may be the DMA configuration used to store input data into the target input feature map (i.e., the above-mentioned constructed target input feature map without writing the data in the original input feature map in an initial state), so the input data may be stored into the target input feature map according to the third DMA configuration information; and such writing process may also be process of writing the source address data into the destination address (the target input feature map), thereby moving the data from the original input feature map into the target input feature map.

In the above-mentioned embodiments, the first DMA configuration information, the second DMA configuration information, and the third DMA configuration information may all include the X direction count configuration (X_COUNT), the X direction stride configuration (X_STRIDE), the Y direction count configuration (Y_COUNT), and the Y direction stride configuration (Y_STRIDE).

In another embodiment, the first DMA configuration information, the second DMA configuration information, and the third DMA configuration information may further include the Z direction count configuration (Z_COUNT) and the Z direction stride configuration (Z_STRIDE).

Based on the above-mentioned technical solutions, in the embodiments of the present disclosure, the data movement in the CNN may be implemented by the DMA controller, not by the CPU, thereby reducing the CPU load, moving data more efficiently, and further accelerating the CNN operation without losing flexibility.

The above-mentioned solutions are described in detail in combination with multiple application scenarios hereinafter.

Application Scenario 1: Special Pattern Generation.

In one embodiment, various image algorithms may involve operations on fixed matrices, including Gaussian matrices in Gaussian filtering, Laplacian matrices and Sobel matrices in edge detection, fast Fourier transform or trigonometric function matrices in Hough transform, Toeplitz matrices in accelerated matrix multiplication, random matrices, all 0/1 matrices, and the like. Based on the above-mentioned description, the DMA controller may be used to generate above-mentioned matrices, thereby reducing the CPU load.

In one embodiment, the process of constructing the target input feature map by the DMA controller according to the first DMA configuration information may be actually the process of constructing matrices according to the first DMA configuration information. The matrix constructing process may be implemented by the DMA controller, not by the CPU.

According to actual needs, if the target input feature map is needed to be the Gaussian matrix, the target input feature map constructed by the DMA controller may be the Gaussian matrix; if the target input feature map is needed to be the trigonometric function matrix, the target input feature map constructed by the DMA controller may be the trigonometric function matrix; if the target input feature map is needed to be the all-zero matrix, the target input feature map constructed by the DMA controller may be the all-zero matrix; if the target input feature map is needed to be the all-one matrix, the target input feature map constructed by the DMA controller may be the all-one matrix; and so on, which may not be limited in the embodiments of the present disclosure. The all-zero matrix may be taken as an example in the embodiments of the present disclosure.

In order to implement the above-mentioned process, specific type information may be stored in specified storage locations, and the specific type information may represent the matrix type. For example, when the specific type information is a first identifier, it may indicate that the matrix type is the all-zero matrix (for various types of padding or interpolation); when the specific type information is a second identifier, it may indicate that the matrix type is the all-one matrix (for various types of padding); when the specific type information is a third identifier, it may indicate that the matrix type is the Gaussian matrix (for 2D/3D Gaussian filtering); when the specific type information is a fourth identifier, it may indicate that the matrix type is the Laplacian matrix (for edge detection); when the specific type information is a fifth identifier, it may indicate that the matrix type is the Sobel matrix (for edge detection); when the specific type information is a sixth identifier, it may indicate that the matrix type is the trigonometric function matrix (for fast Fourier transform or Huff transform); when the specific type information is a seventh identifier, it may indicate that the matrix type is the Toeplitz matrix (for matrix multiplication acceleration); when the specific type information is an eighth identifier, it may indicate that the matrix type is the random matrix (used to train weight initialization); which may not be limited according to the embodiments of the present disclosure.

The process of “constructing the target input feature map according to the first DMA configuration information” may include, but may not be limited to, the following manners: the DMA controller may read the specific type information from the specified storage locations, and construct the target input feature map corresponding to the specific type information according to the first DMA configuration information. For example, when the specific type information is the first identifier, it may indicate that the matrix type is the all-zero matrix, so constructing the target input feature map corresponding to the specific type information according to the first DMA configuration information may include constructing the target input feature map with all zeros according to the first DMA configuration information.

In one embodiment, certain special addresses (e.g., 0xFFFF FFFF, 0x8765_4321, 0x5A5A_5A5A, and the like) may be configured as the specified storage locations or certain fields of control flow graph (CFG) registers may be configured as the specified storage locations, thereby storing the specific type information in the specified storage location to specify the matrix type. In such way, the DMA controller may read the specific type information from the specified storage locations, then obtain the matrix type and construct the target input feature map corresponding to the matrix type.

In one embodiment, when the target input feature map is constructed by the DMA controller, the data of the target input feature map may be generated by the DMA controller itself (e.g., generating all-zero data), and there may be no need to read data from other locations. Therefore, there is no need to configure the first DMA configuration information for the read process, and the first DMA configuration information may merely be configured for the write process. Based on the first DMA configuration information, the DMA controller may write the data generated by itself to the target input feature map, that is, may construct the target input feature map.

In one embodiment, seven registers may be configured for the write process. The seven registers may respectively store a starting address (DST_STRT_ADDR), the X-direction count configuration (X_COUNT), the X-direction stride configuration (X_STRIDE), the Y-direction count configuration (Y_COUNT), the Y-direction stride configuration (Y_STRIDE), the Z-direction count configuration (Z_COUNT), and the Z-direction stride configuration (Z_STRIDE).

Based on the above-mentioned seven registers, the DMA controller may obtain the first DMA configuration information and construct the target input feature map using the starting address and the first DMA configuration information.

Application Scenario 2: The Input Feature Map Padding.

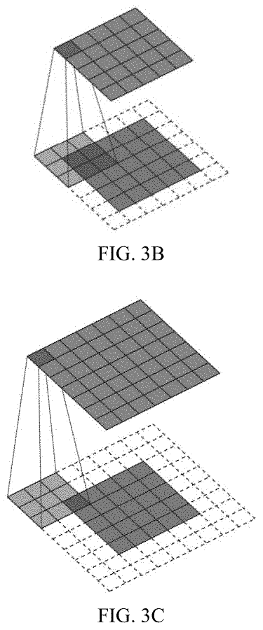

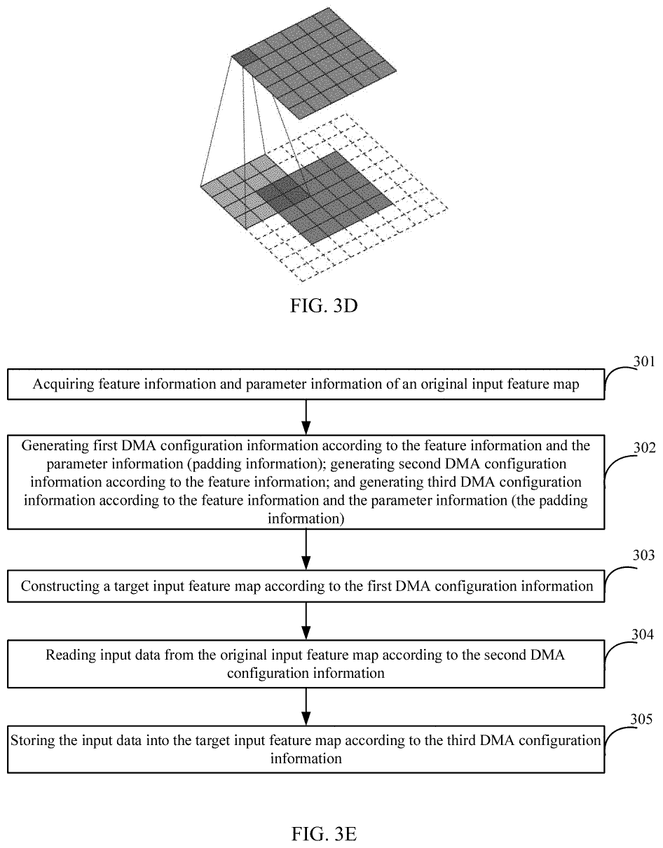

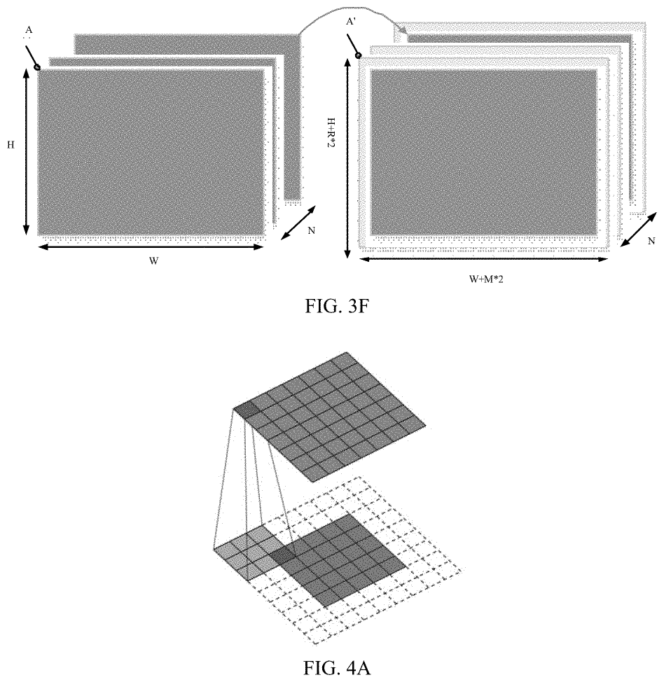

FIG. 3A shows a 2D convolution example with no padding, a convolution kernel of 3*3, and the stride length of 1. From FIG. 3A, it can be seen that the size of the input feature map may be 5*5, and the size of the output feature map may become 3*3 when there is no padding. In order to obtain the output feature map having the same size as the input feature map, one layer (e.g., one row or one column) of zeros may be added to each edge of the input feature map; and such method of zero padding is called half-padding, shown in FIG. 3B. In practical applications, two layers (e.g., two rows or two columns) of zeros may be added to each edge of the input feature map; and such method of zero padding is called full-padding, shown in FIG. 3C. In practical applications, any layers (e.g., any rows or any columns) of zeros may be added to each edge of the input feature map; and such method of zero padding is called arbitrary-padding, shown in FIG. 3D.

If the above-mentioned padding operation is completed by the CPU, it may greatly increase the CPU load. Therefore, the above-mentioned padding operation may be completed by the DMA controller, thereby reducing the CPU load. The above-mentioned operation may be used to perform the padding process on the original input feature map, which may be described in detail with reference to FIG. 3E.

At step 301, the feature information and the parameter information of the original input feature map may be acquired.

It is assumed that the original input feature map has the width of W, the height of H, and the quantity N of channels, and is stored contiguously in memory with a starting address of A. The size of left and right padding along the horizontal direction may be M (i.e., along the horizontal direction, the size of left padding may be M and the size of right padding may be M). The size of top and bottom padding along the vertical direction may be R (i.e., along the vertical direction, the size of top padding may be R and the size of bottom padding may be R). The input feature map after padding may be stored contiguously in memory with a starting address of A′. Therefore, the feature information may include the width W and the height H of the original input feature map. The above-mentioned parameter information may be the padding information, and the padding information may include the padding size M along the horizontal direction and the padding size R along the vertical direction. Furthermore, the above-mentioned feature information may further include the quantity N of channels.

At step 302, the second DMA configuration information may be generated according to the feature information, and the first DMA configuration information and the third DMA configuration information may be generated according to the feature information and the parameter information (e.g., the padding information).

Case 1: the process of “generating the first DMA configuration information according to the feature information and the parameter information” may include generating the first DMA configuration information according to the feature information and the padding information.

For example, the X-direction count configuration may be generated according to the width W and the padding size M, and the Y-direction count configuration may be generated according to the height H and the padding size R. Furthermore, the X-direction stride configuration and the Y-direction stride configuration may be generated according to preset values (e.g., 1). In another embodiment, the Z-direction count configuration may be generated according to the quantity N of channels, and the Z-direction stride configuration may be generated according to a preset value (e.g., 1).

For example, the first DMA configuration information in one embodiment may include the X-direction count configuration of (W+M*2), the Y-direction count configuration of (H+R*2), the X-direction stride configuration of 1, and the Y-direction stride configuration of 1. In addition, the first DMA configuration information may further include the Z-direction count configuration of N, and the Z-direction stride configuration of 1.

Obviously, the above-mentioned first DMA configuration information may merely be an example which may not be limited in the embodiments of the present disclosure and may be configured based on experience. The above-mentioned first DMA configuration information may be used as an example in the embodiments of the present disclosure.

Case 2: the process of “generating the second DMA configuration information according to the feature information” may include, but may not be limited to, generating the X-direction count configuration according to the width W and generating the Y-direction count configuration according to the height H. In addition, the X-direction stride configuration and the Y-direction stride configuration may be generated according to preset values (e.g., 1). In another embodiment, the Z-direction count configuration may be generated according to the quantity N of channels, and the Z-direction stride configuration may be generated according to a preset value (e.g., 1).

For example, the second DMA configuration information in one embodiment may include the X-direction count configuration of W, the Y-direction count configuration of H, the X-direction stride configuration of 1, and the Y-direction stride configuration of 1. In addition, the second DMA configuration information may further include the Z-direction count configuration of N, and the Z-direction stride configuration of 1.

Obviously, the above-mentioned second DMA configuration information may merely be an example which may not be limited in the embodiments of the present disclosure and may be configured based on experience. The above-mentioned second DMA configuration information may be used as an example in the embodiments of the present disclosure.

Case 3: the process of “generating the third DMA configuration information according to the feature information and the parameter information” may include generating the third DMA configuration information according to the feature information and the padding information.

For example, the X-direction count configuration may be generated according to the width W, and the Y-direction count configuration may be generated according to the height H. Furthermore, the X-direction stride configuration may be generated according to a preset value (e.g., 1), and the Y-direction stride configuration may be generated according to the padding size M. In another embodiment, the Z-direction count configuration may be generated according to the quantity N of channels, and the Z-direction stride configuration may be generated according to the width W, the padding size M and the padding size R.

For example, the third DMA configuration information in one embodiment may include the X-direction count configuration of W, the Y-direction count configuration of H, the X-direction stride configuration of 1, and the Y-direction stride configuration of M*2. In addition, the third DMA configuration information may further include the Z-direction count configuration of N, and the Z-direction stride configuration of (W+M*2)*R*2+M*2.

Obviously, the above-mentioned third DMA configuration information may merely be an example which may not be limited in the embodiments of the present disclosure and may be configured based on experience. The above-mentioned third DMA configuration information may be used as an example in the embodiments of the present disclosure.

At step 303, the target input feature map may be constructed according to the first DMA configuration information.

In one embodiment, the DMA controller may construct the target input feature map with the size of (W+M*2)*(H+R*2) according to the first DMA configuration information, or may construct the target input feature map with the size of (W+M*2)*(H+R*2)*N according to the first DMA configuration information, where the target input feature map may be all zeros, and the starting address (i.e., DST_STRT_ADDR) of the target input feature map may be A′.

Referring to FIG. 3F, the target input feature map constructed by the DMA controller according to the first DMA configuration information may have the size of (W+M*2)*(H+R*2) and the quantity N of channels.

At step 304, the input data may be read from the original input feature map according to the second DMA configuration information.

In one embodiment, the DMA controller may read each input data in the original input feature map starting from the starting address A according to the second DMA configuration information.

At step 305, the input data may be stored into the target input feature map according to the third DMA configuration information.

In one embodiment, the DMA controller may store each input data starting from the starting address of the input data into the target input feature map according to the third DMA configuration information, where the starting address of the input data may be A′+(W+M*2)*R+M, and A′ may be the starting address of the target input feature map. The starting address of the input data may be the address of the first input data in the target input feature map.

As shown in FIG. 3F, the DMA controller may move the data in the original input feature map into the all-zero target input feature map constructed at step 303. Therefore, the center of the original input feature map may be coincident with the center of the all-zero target input feature map, the data movement may be completed, and finally, the target input feature map which meets requirements may be obtained. The target input feature map may have implemented the padding process on the original input feature map.

Application Scenario 3: A De-Convolution, Also Known as a Transposed Convolution.

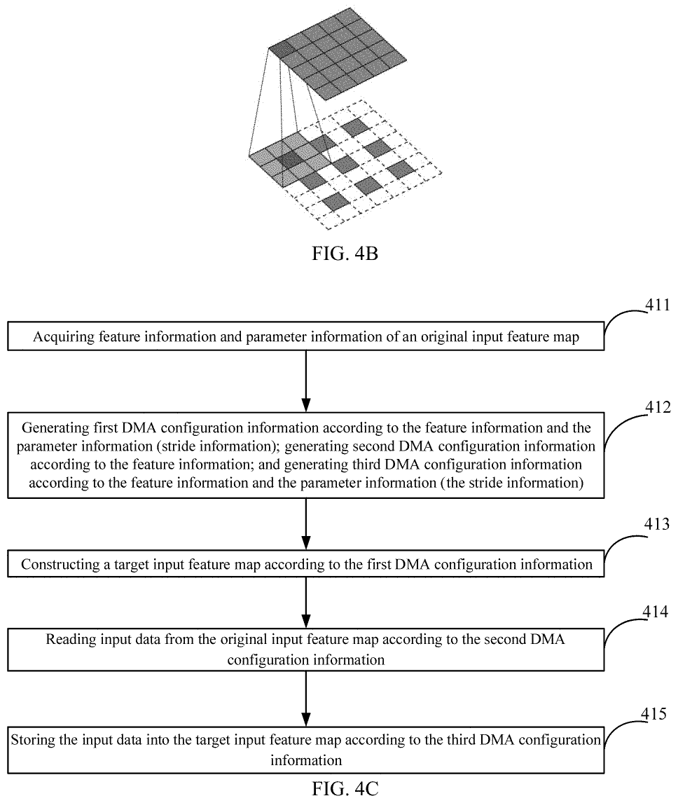

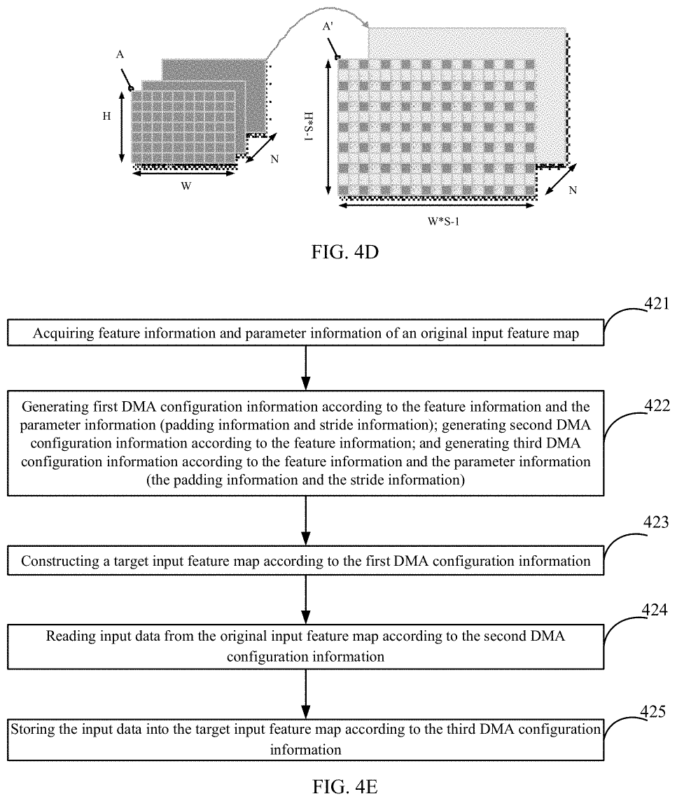

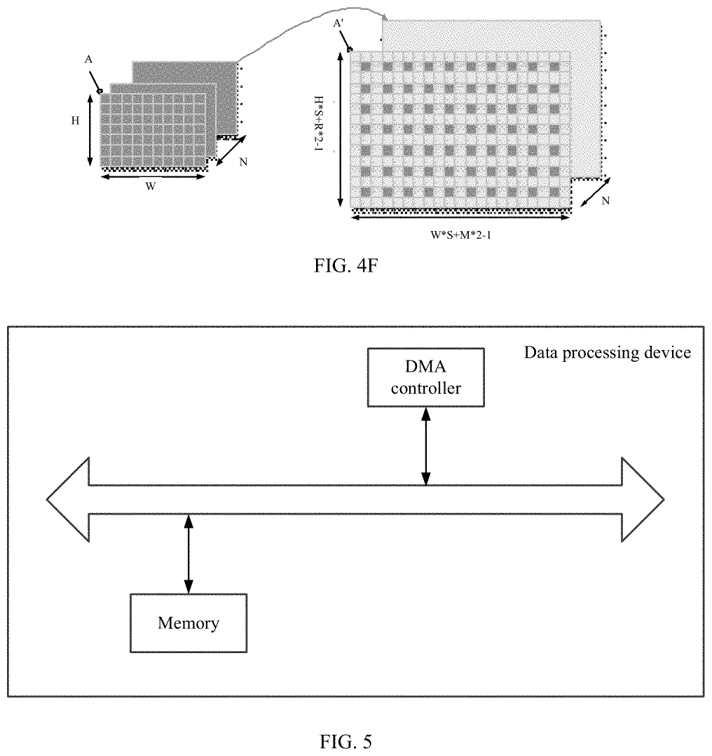

Referring to FIG. 4A, when the stride is equal to 1, the de-convolution operation process may be similar to the convolution operation process. Referring to FIG. 4B, when the stride is greater than 1, the convolution kernel of the de-convolution may become a convolution with a “hole”, that is, a micro-step convolution, and the “hole” may be used to make the stride of the de-convolution to be 1/i times of the forward convolution, so the convolution kernel may move at a smaller stride.

When the stride is greater than 1, the original input feature map may need to be interpolated with multiple zeros to implement the reshape (a function used to readjust, for example, the quantity of rows, the quantity of columns, and the quantity of dimensions of the matrix) of the output matrix. In various embodiments, the quantity of dimensions of the matrix may or may not be readjusted to implement the reshape of the output matrix. If the above-mentioned operation of interpolating zero into the original input feature map is completed by the CPU, the load of the CPU may be greatly increased.

Based on the above-mentioned description, the DMA controller may be used to complete the operation of interpolating zero into the original input feature map, thereby reducing the CPU load. The above-mentioned operation may be used to perform the de-convolution process on the original input feature map.

In the present disclosure, the de-convolution process may be divided into a first de-convolution process and a second de-convolution process. The first de-convolution process may be the de-convolution process without padding process, and the second de-convolution process may be the de-convolution process with padding process.

FIG. 4C is a schematic of the first de-convolution process without padding process.

At step 411, the feature information and the parameter information of the original input feature map may be acquired.

It is assumed that the original input feature map has the width of W, the height of H, and the quantity N of channels, and is stored contiguously in memory with the starting address of A. The stride length of the de-convolution may be S, and the pre-processed original input feature map may be stored contiguously in memory with the starting address of A′. Therefore, the feature information may include the width W and the height H of the original input feature map. The above-mentioned parameter information may be the stride information, and the stride information may include the stride length S in the first de-convolution process. Furthermore, the above-mentioned feature information may further include the quantity N of channels.

At step 412, the second DMA configuration information may be generated according to the feature information, and the first DMA configuration information and the third DMA configuration information may be generated according to the feature information and the parameter information (e.g., the stride information).

Case 1: the process of “generating the first DMA configuration information according to the feature information and the parameter information” may include generating the first DMA configuration information according to the feature information and the stride information.

For example, the X-direction count configuration may be generated according to the width W and the stride length S, and the Y-direction count configuration may be generated according to the height H and the stride length S. The X-direction stride configuration and the Y-direction stride configuration may be generated according to preset values (e.g., 1). In another embodiment, the Z-direction count configuration may be generated according to the quantity N of channels, and the Z-direction stride configuration may be generated according to a preset value (e.g., 1).

For example, the first DMA configuration information in one embodiment may include the X-direction count configuration of W*S−1, the Y-direction count configuration of H*S−1, the X-direction stride configuration of 1, and the Y-direction stride configuration of 1. In addition, the first DMA configuration information may further include the Z-direction count configuration of N, and the Z-direction stride configuration of 1.

Obviously, the above-mentioned first DMA configuration information may merely be an example which may not be limited in the embodiments of the present disclosure and may be configured based on experience. The above-mentioned first DMA configuration information may be used as an example in the embodiments of the present disclosure.

Case 2: the process of “generating the second DMA configuration information according to the feature information” may include, but may not be limited to, generating the X-direction count configuration according to the width W and generating the Y-direction count configuration according to the height H. In addition, the X-direction stride configuration and the Y-direction stride configuration may be generated according to preset values (e.g., 1). In another embodiment, the Z-direction count configuration may be generated according to the quantity N of channels, and the Z-direction stride configuration may be generated according to a preset value (e.g., 1).

For example, the second DMA configuration information in one embodiment may include the X-direction count configuration of W, the Y-direction count configuration of H, the X-direction stride configuration of 1, and the Y-direction stride configuration of 1. In addition, the second DMA configuration information may further include the Z-direction count configuration of N, and the Z-direction stride configuration of 1.

Obviously, the above-mentioned second DMA configuration information may merely be an example which may not be limited in the embodiments of the present disclosure and may be configured based on experience. The above-mentioned second DMA configuration information may be used as an example in the embodiments of the present disclosure.

Case 3: the process of “generating the third DMA configuration information according to the feature information and the parameter information” may include generating the third DMA configuration information according to the feature information and the stride information.

For example, the X-direction count configuration may be generated according to the width W, and the Y-direction count configuration may be generated according to the height H. The X-direction stride configuration may be generated according to the stride length S and the Y-direction stride configuration may be generated according to the width W and the stride length S. In another embodiment, the Z-direction count configuration may be generated according to the quantity N of channels, and the Z-direction stride configuration may be generated according to a preset value (e.g., 1).

For example, the third DMA configuration information in one embodiment may include the X-direction count configuration of W, the Y-direction count configuration of H, the X-direction stride configuration of S, and the Y-direction stride configuration of W*S−1. In addition, the third DMA configuration information may further include the Z-direction count configuration of N, and the Z-direction stride configuration of 1.

Obviously, the above-mentioned third DMA configuration information may merely be an example which may not be limited in the embodiments of the present disclosure and may be configured based on experience. The above-mentioned third DMA configuration information may be used as an example in the embodiments of the present disclosure.

At step 413, the target input feature map may be constructed according to the first DMA configuration information.

In one embodiment, the DMA controller may construct the target input feature map with the size of (W*S−1)*(H*S−1) according to the first DMA configuration information, or may construct the target input feature map with the size of (W*S−1)*(H*S−1)*N according to the first DMA configuration information, where the target input feature map may be all zeros, and the starting address (i.e., DST_STRT_ADDR) of the target input feature map may be A′.

Referring to FIG. 4D, the target input feature map constructed by the DMA controller according to the first DMA configuration information may have the size of (W*S−1)*(H*S−1) and the quantity N of channels.

At step 414, the input data may be read from the original input feature map according to the second DMA configuration information.

In one embodiment, the DMA controller may read each input data in the original input feature map starting from the starting address A according to the second DMA configuration information.

At step 415, the input data may be stored into the target input feature map according to the third DMA configuration information.

In one embodiment, the DMA controller may store each input data starting from the starting address A′ of the target input feature map into the target input feature map according to the third DMA configuration information.

As shown in FIG. 4D, the DMA controller may move the data in the original input feature map into the all-zero target input feature map constructed at step 413. Therefore, the center of the original input feature map may be coincident with the center of the all-zero target input feature map, the data movement may be completed, and finally, the target input feature map which meets requirements may be obtained. The target input feature map may have implemented the de-convolution process on the original input feature map.

FIG. 4E is a schematic of the de-convolution process with padding process.

At step 421, the feature information and the parameter information of the original input feature map may be acquired.

It is assumed that the original input feature map has the width of W, the height of H, and the quantity N of channels, and is stored contiguously in memory with the starting address of A. The size of left and right padding along the horizontal direction may be M (i.e., along the horizontal direction, the size of left padding may be M and the size of right padding may be M). The size of top and bottom padding along the vertical direction may be R (i.e., along the vertical direction, the size of top padding may be R and the size of bottom padding may be R). The stride length of the de-convolution may be S and the pre-processed original input feature map may be stored contiguously in memory with the starting address of A′. Therefore, the feature information may include the width W and the height H of the original input feature map. The parameter information may be the padding information and the stride information. The padding information may include the padding size M along the horizontal direction and the padding size R along the vertical direction. The stride information may include the stride length S of the second de-convolution process. Furthermore, the above-mentioned feature information may further include the quantity N of channels.

At step 422, the second DMA configuration information may be generated according to the feature information, and the first DMA configuration information and the third DMA configuration information may be generated according to the feature information and the parameter information (e.g., the padding information and the stride information).

Case 1: the process of “generating the first DMA configuration information according to the feature information and the parameter information” may include generating the first DMA configuration information according to the feature information, the padding information and the stride information.

For example, the X-direction count configuration may be generated according to the width W, the stride length S and the padding size M, and the Y-direction count configuration may be generated according to the height H, the stride length S and the padding size R. The X-direction stride configuration and the Y-direction stride configuration may be generated according to preset values (e.g., 1). In another example, the Z-direction count configuration may be generated according to the quantity N of channels, and the Z-direction stride configuration may be generated according to a preset value.

For example, the first DMA configuration information in one embodiment may include the X-direction count configuration of W*S+M*2−1, the Y-direction count configuration of H*S+R*2−1, the X-direction stride configuration of 1, and the Y-direction stride configuration of 1. In addition, the first DMA configuration information may further include the Z-direction count configuration of N, and the Z-direction stride configuration of 1.

Obviously, the above-mentioned first DMA configuration information may merely be an example which may not be limited in the embodiments of the present disclosure and may be configured based on experience. The above-mentioned first DMA configuration information may be used as an example in the embodiments of the present disclosure.

Case 2: the process of “generating the second DMA configuration information according to the feature information” may include, but may not be limited to, generating the X-direction count configuration according to the width W and generating the Y-direction count configuration according to the height H. In addition, the X-direction stride configuration and the Y-direction stride configuration may be generated according to preset values (e.g., 1). In another embodiment, the Z-direction count configuration may be generated according to the quantity N of channels, and the Z-direction stride configuration may be generated according to a preset value (e.g., 1).

For example, the second DMA configuration information in one embodiment may include the X-direction count configuration of W, the Y-direction count configuration of H, the X-direction stride configuration of 1, and the Y-direction stride configuration of 1. In addition, the second DMA configuration information may further include the Z-direction count configuration of N, and the Z-direction stride configuration of 1.

Obviously, the above-mentioned second DMA configuration information may merely be an example which may not be limited in the embodiments of the present disclosure and may be configured based on experience. The above-mentioned second DMA configuration information may be used as an example in the embodiments of the present disclosure.

Case 3: the process of “generating the third DMA configuration information according to the feature information and the parameter information” may include generating the third DMA configuration information according to the feature information, the padding information and the stride information.

For example, the X-direction count configuration may be generated according to the width W, and the Y-direction count configuration may be generated according to the height H. The X-direction stride configuration may be generated according to the stride length S and the Y-direction stride configuration may be generated according to the width W, the stride length S and the padding size M. In another embodiment, the Z-direction count configuration may be generated according to the quantity N of channels, and the Z-direction stride configuration may be generated according to the width W, the stride length S, the padding size M, and the padding size R.

For example, the third DMA configuration information in one embodiment may include the X-direction count configuration of W, the Y-direction count configuration of H, the X-direction stride configuration of S, and the Y-direction stride configuration of W*S+M*2−1+M*2.

In another embodiment, the third DMA configuration information may further include the Z-direction count configuration of N, and the Z-direction stride configuration of (W*S+M*2−1)*R*2+M*2.

Obviously, the above-mentioned third DMA configuration information may merely be an example which may not be limited in the embodiments of the present disclosure and may be configured based on experience. The above-mentioned third DMA configuration information may be used as an example in the embodiments of the present disclosure.

At step 423, the target input feature map may be constructed according to the first DMA configuration information.

In one embodiment, the DMA controller may construct the target input feature map with the size of (W*S+M*2−1)*(H*S+R*2−1) according to the first DMA configuration information, or may construct the target input feature map with the size of (W*S+M*2−1)*(H*S+R*2−1)*N according to the first DMA configuration information, where the target input feature map may be all zeros, and the starting address (i.e., DST_STRT_ADDR) of the target input feature map may be A′.

Referring to FIG. 4F, the target input feature map constructed by the DMA controller according to the first DMA configuration information may have the size of (W*S+M*2−1)*(H*S+R*2−1) and the quantity N of channels.

At step 424, the input data may be read from the original input feature map according to the second DMA configuration information.

In one embodiment, the DMA controller may read each input data in the original input feature map starting from the starting address A according to the second DMA configuration information.

At step 425, the input data may be stored into the target input feature map according to the third DMA configuration information.

In one embodiment, the DMA controller may store each input data starting from the starting address of the input data into the target input feature map according to the third DMA configuration information, where the starting address of the input data may be A′+(W*S+M*2−1)*R+M, A′ may be the starting address of the target input feature map, and the starting address of the input data may be the address of the first input data in the target input feature map.

As shown in FIG. 4F, the DMA controller may move the data in the original input feature map into the all-zero target input feature map constructed at step 423. Therefore, the center of the original input feature map may be coincident with the center of the all-zero target input feature map, the data movement may be completed, and finally, the target input feature map which meets requirements may be obtained. The target input feature map may have implemented the de-convolution process on the original input feature map.

Based on the same concept as the above-mentioned method, the embodiments of the present disclosure provide a DMA controller. The DMA controller may be configured to:

acquire feature information and parameter information of an original input feature map;

generate second DMA configuration information according to the feature information, and generate first DMA configuration information and third DMA configuration information according to the feature information and the parameter information;

construct a target input feature map according to the first DMA configuration information;

read input data from the original input feature map according to the second DMA configuration information; and

store the input data in the target input feature map according to the third DMA configuration information.

When generating the first DMA configuration information according to the feature information and the parameter information, the DMA controller may be configured to:

when performing the padding process on the original input feature map, generate the first DMA configuration information according to the feature information and the padding information; or

when performing a first de-convolution on the original input feature map, generate the first DMA configuration information according to the feature information and the stride information; or

when performing a second de-convolution on the original input feature map, generate the first DMA configuration information according to the feature information, the padding information, and the stride information.

The feature information may include the width W and the height H of the original input feature map. The padding information may include the padding size M along the horizontal direction and the padding size R along the vertical direction. When generating the first DMA configuration information according to the feature information and the padding information, the DMA controller may be configured to: generate the X-direction count configuration according to the width W and the padding size M, generate the Y-direction count configuration according to the height H and the padding size R, and generate the X-direction stride configuration and the Y-direction stride configuration according to preset values.

The feature information may include the width W and the height H of the original input feature map. The stride information may include the stride length S of the first de-convolution process. When generating the first DMA configuration information according to the feature information and the stride information, the DMA controller may be configured to: generate the X-direction count configuration according to the width W and the stride length S, generate the Y-direction count configuration according to the height H and the stride length S, and generate the X-direction stride configuration and the Y-direction stride configuration according to preset values.

The feature information may include the width W and the height H of the original input feature map. The padding information may include the padding size M along the horizontal direction and the padding size R along the vertical direction. The stride information may include the stride length S of the second de-convolution process. When generating the first DMA configuration information according to the feature information, the padding information and the stride information, the DMA controller may be configured to: generate the X-direction count configuration according to the width W, the stride length S and the padding size M, generate the Y-direction count configuration according to the height H, the stride length S and the padding size R, and generate the X-direction stride configuration and the Y-direction stride configuration according to preset values.

The feature information may further include the quantity N of channels. When generating the first DMA configuration information according to the feature information and the parameter information, the DMA controller may be configured to: generate the Z-direction count configuration according to the quantity N of channels and generate the Z-direction stride configuration according to a preset value.

The feature information may include the width W and the height H of the original input feature map.

When generating the second DMA configuration information according to the feature information, the DMA controller may be configured to: when performing the padding process on the original input feature map, or when performing the first de-convolution on the original input feature map, or when performing the second de-convolution on the original input feature map, generate the X-direction count configuration according to the width W, generate the Y-direction count configuration according to the height H, and generate the X-direction stride configuration and the Y-direction stride configuration according to preset values.

The feature information may further include the quantity N of channels. When generating the second DMA configuration information according to the feature information, the DMA controller may be configured to: generate the Z-direction count configuration according to the quantity N of channels and generate the Z-direction stride configuration according to a preset value.

When generating the third DMA configuration information according to the feature information and the parameter information, the DMA controller may be configured to:

when performing the padding process on the original input feature map, generate the third DMA configuration information according to the feature information and the padding information; or

when performing the first de-convolution on the original input feature map, generate the third DMA configuration information according to the feature information and the stride information; or

when performing the second de-convolution on the original input feature map, generate the third DMA configuration information according to the feature information, the padding information and the stride information.

The feature information may include the width W and the height H of the original input feature map. The padding information may include the padding size M along the horizontal direction and the padding size R along the vertical direction. When generating the third DMA configuration information according to the feature information and the padding information, the DMA controller may be configured to: generate the X-direction count configuration according to the width W, generate the Y-direction count configuration according to the height H, generate the X-direction stride configuration according to a preset value, and generate the Y-direction stride configuration according to the padding size M.

The feature information may include the width W and the height H of the original input feature map. The stride information may include the stride length S of the first de-convolution process. When generating the third DMA configuration information according to the feature information and the stride information, the DMA controller may be configured to: generate the X-direction count configuration according to the width W, generate the Y-direction count configuration according to the height H, generate the X-direction stride configuration according to the stride length S, and generate the Y-direction stride configuration according to the width W and the stride length S.

The feature information may include the width W and the height H of the original input feature map. The padding information may include the padding size M along the horizontal direction and the padding size R along the vertical direction. The stride information may include the stride length S of the second de-convolution process.

When generating the third DMA configuration information according to the feature information, the padding information and the stride information, the DMA controller may be configured to: generate the X-direction count configuration according to the width W, generate the Y-direction count configuration according to the height H, generate the X-direction stride configuration according to the stride length S, and generate the Y-direction stride configuration according to the width W, the stride length S, and the padding size M.

The feature information may further include the quantity N of channels. When generating the third DMA configuration information according to the feature information and the padding information, the DMA controller may be configured to: generate the Z-direction count configuration according to the quantity N of channels, and also generate the Z-direction stride configuration according to the width W, the padding size M and the padding size R.

The feature information may further include the quantity N of channels. When generating the third DMA configuration information according to the feature information and the stride information, the DMA controller may be configured to: generate the Z-direction count configuration according to the quantity N of channels, and also generate the Z-direction stride configuration according to a preset value.

The feature information may further include the quantity N of channels. When generating the third DMA configuration information according to the feature information, the padding information and the stride information, the DMA controller may be configured to: generate the Z-direction count configuration according to the quantity N of channels, and also generate the Z-direction stride configuration according to the width W, the stride length S, the padding size M and the padding size R.

When constructing the target input feature map according to the first DMA configuration information, the DMA controller may be configured to read specific type information from specified storage locations and construct the target input feature map corresponding to the specific type information according to the first DMA configuration information.

Based on the same concept as the above-mentioned method, the embodiments of the present disclosure further provide a data processing device. As shown in FIG. 5, the data processing device may include a memory and a DMA controller. The memory may be configured to store program code, and the DMA controller may be configured to call the program code. When the program code is executed, the above-mentioned data processing method required by the claims of the present disclosure may be implemented.

Based on the same concept as the above-mentioned method, the embodiments of the present disclosure further provide a computer-readable storage medium. The computer-readable storage medium stores a quantity of computer instructions. When the computer instructions are executed, the above-mentioned data processing method required by the claims of the present disclosure may be implemented.

The system, device, module or unit described in the above-mentioned embodiments may be implemented by a computer chip or entity, or by a product having a certain function. A typical implementation device may be a computer, and the specific form of the computer may be a personal computer, a laptop computer, a cellular phone, a camera phone, a smart phone, a personal digital assistant, a media player, a navigation device, an email sending and receiving device, a game console, a tablet computer, a wearable device, or a combination of any of such devices.

For the convenience of description, the above-mentioned devices are divided into various units according to functions and described separately. Obviously, when implementing the present disclosure, the function of each unit may be implemented in the one or more software and/or hardware.

Those skilled in the art should understand that the embodiments of the present disclosure may be provided as a method, a system, or a computer program product. Therefore, the present disclosure may take the form of an entirely hardware embodiment, an entirely software embodiment, or an embodiment combining software and hardware aspects. Moreover, the embodiments of the present disclosure may take the form of a computer program product implemented on one or more computer-usable storage media (including, but not limited to, magnetic disk memory, CD-ROM, optical memory, and the like) containing computer-usable program code.

The present disclosure may be described with reference to flowcharts and/or block diagrams of methods, devices (systems), and computer program products according to embodiments of the present disclosure. It should be understood that each process and/or block in the flowcharts and/or block diagrams, and combinations of processes and/or blocks in the flowcharts and/or block diagrams, can be implemented by computer program instructions. These computer program instructions may be provided to a general-purpose computer, a special-purpose computer, an embedded processor, or processors of other programmable data processing devices to produce machine code, so that the instructions executed by the processors of the computer or other programmable data processing devices may be used to generate devices for implementing the functions specified in one or more processes in the flowcharts and/or one or more blocks in the block diagrams.

Furthermore, the computer program instructions may also be stored in a computer-readable memory capable of directing a computer or other programmable data processing devices to work in a specific manner, so that the instructions stored in the computer-readable memory may produce manufactured products including an instruction device. The instruction device may implement the functions specified in one or more processes in the flowcharts and/or one or more blocks in the block diagrams.

The computer program instructions may further be loaded into a computer or other programmable data processing devices, so that a series of operating steps are performed on the computer or other programmable devices to produce a computer-implemented processing.

Therefore, the instructions executed on the computer or other programmable devices may provide steps for implementing the functions specified in one or more processes in the flowcharts and/or one or more blocks in the block diagrams.

The above-mentioned description may merely the embodiment of the present disclosure and may not intended to limit the scope of the present disclosure. It may be apparent to those skilled in the art that various modifications and variations may be made in the present disclosure. Any modification, equivalent replacement and improvement made within the spirit and principle of the present disclosure should be included in the scope of the claims of the present disclosure.

What is claimed is:

1. A data processing method, applied to a direct memory access (DMA) controller, comprising:
acquiring feature information and parameter information of an original input feature map;
generating first DMA configuration information according to the feature information and the parameter information;
generating second DMA configuration information according to the feature information;
generating third DMA configuration information according to the feature information and the parameter information;
constructing a target input feature map according to the first DMA configuration information;
reading input data from the original input feature map according to the second DMA configuration information; and
storing the input data into the target input feature map according to the third DMA configuration information.

2. The method according to claim 1, wherein:
generating the first DMA configuration information according to the feature information and the parameter information includes:
when performing a padding process on the original input feature map, generating the first DMA configuration information according to the feature information and padding information.

3. The method according to claim 2, wherein:
the feature information includes a width W and a height H of the original input feature map;
the padding information includes a padding size M along a horizontal direction and a padding size R along a vertical direction;
generating the first DMA configuration information according to the feature information and the padding information includes:
generating X-direction count configuration according to the width W and the padding size M;
generating Y-direction count configuration according to the height H and the padding size R; and
generating X-direction stride configuration and Y-direction stride configuration according to preset values.

4. The method according to claim 3, wherein:
the first DMA configuration information includes:
the X-direction count configuration of (W+M*2);
the Y-direction count configuration of (H+R*2);
the X-direction stride configuration of 1; and
the Y-direction stride configuration of 1.

5. The method according to claim 3, wherein:
the feature information further includes a quantity N of channels; and
generating the first DMA configuration information according to the feature information and the parameter information further includes:
generating Z-direction count configuration according to the quantity N of channels; and
generating Z-direction stride configuration according to a preset value.

6. The method according to claim 3, wherein:
constructing the target input feature map according to the first DMA configuration information includes:
constructing the target input feature map with a size of (W+M*2)*(H+R*2) according to the first DMA configuration information, wherein values in the target input feature map are all zeros, and a starting address is A′.

7. The method according to claim 1, wherein:
the feature information includes a width W and a height H of the original input feature map;
generating the second DMA configuration information according to the feature information includes:
when performing a padding process on the original input feature map, generating X-direction count configuration according to the width W, and generating Y-direction count configuration according to the height H; and
generating X-direction stride configuration and Y-direction stride configuration according to preset values.

8. The method according to claim 7, wherein:
the second DMA configuration information includes:
the X-direction count configuration of W;
the Y-direction count configuration of H;
the X-direction stride configuration of 1; and
the Y-direction stride configuration of 1.

9. The method according to claim 7, wherein:
the feature information further includes a quantity N of channels; and
generating the second DMA configuration information according to the feature information further includes:
generating Z-direction count configuration according to the quantity N of channels; and
generating Z-direction stride configuration according to a preset value.

10. The method according to claim 7, wherein:
reading the input data from the original input feature map according to the second DMA configuration information includes:
reading each input data in the original input feature map from a starting address A according to the second DMA configuration information.

11. The method according to claim 1, wherein:
generating the third DMA configuration information according to the feature information and the parameter information includes:
when performing a padding process on the original input feature map, generating the third DMA configuration information according to the feature information and padding information.

12. The method according to claim 11, wherein:
the feature information includes a width W and a height H of the original input feature map;
the padding information includes a padding size M along a horizontal direction and a padding size R along a vertical direction;
generating the third DMA configuration information according to the feature information and the padding information includes:
generating X-direction count configuration according to the width W;
generating Y-direction count configuration according to the height H;
generating X-direction stride configuration according to a preset value; and
generating Y-direction stride configuration according to the padding size M.

13. The method according to claim 12 wherein:
the third DMA configuration information includes:
the X-direction count configuration of W;
the Y-direction count configuration of H;
the X-direction stride configuration of 1; and
the Y-direction stride configuration of M*2.

14. The method according to claim 12, wherein:
the feature information further includes a quantity N of channels; and
generating the third DMA configuration information according to the feature information and the padding information further includes:
generating Z-direction count configuration according to the quantity N of channels; and
generating Z-direction stride configuration according to the width W, the padding size M, the padding size R.

15. The method according to claim 12, wherein:
storing the input data into the target input feature map according to the third DMA configuration information includes:
according to the third DMA configuration information, storing each input data starting from a starting address of the input data into the target input feature map, wherein the starting address of the input data is (A′+(W+M*2)*R+M), and A′ is a starting address of the target input feature map.

16. The method according to claim 1, wherein:
generating the first DMA configuration information according to the feature information and the parameter information includes:
when performing a first de-convolution process on the original input feature map, generating the first DMA configuration information according to the feature information and stride information.

17. The method according to claim 16, wherein:
the feature information includes a width W and a height H of the original input feature map;
the stride information includes a stride length S of the first de-convolution process; and
generating the first DMA configuration information according to the feature information and the stride information includes:
generating X-direction count configuration according to the width W and the stride length S;
generating Y-direction count configuration according to the height H and the stride length S; and
generating X-direction stride configuration and Y-direction stride configuration according to preset values.

18. The method according to claim 17, wherein:
the first DMA configuration information includes:
the X-direction count configuration of (W*S−1);
the Y-direction count configuration of (H*S−1);
the X-direction stride configuration of 1; and
the Y-direction stride configuration of 1.

19. A direct memory access (DMA) controller, wherein the DMA controller is configured to:
acquire feature information and parameter information of an original input feature map;
generate first DMA configuration information according to the feature information and the parameter information;
generate second DMA configuration information according to the feature information;
generate third DMA configuration information according to the feature information and the parameter information;
construct a target input feature map according to the first DMA configuration information;
read input data from the original input feature map according to the second DMA configuration information; and
store the input data into the target input feature map according to the third DMA configuration information.

20. A data processing device, comprising:
a memory, configured to store program code; and
a direct memory access (DMA) controller, configured to call the program code, wherein when the program code is executed, the DMA controller is configured to perform:
acquiring feature information and parameter information of an original input feature map;
generating first DMA configuration information according to the feature information and the parameter information;
generating second DMA configuration information according to the feature information;
generating third DMA configuration information according to the feature information and the parameter information;
constructing a target input feature map according to the first DMA configuration information;
reading input data from the original input feature map according to the second DMA configuration information; and
storing the input data into the target input feature map according to the third DMA configuration information.
